(19) United States
(12) Patent Application Publication
(10) Pub. No.: US 2021/0224832 A1
(43) Pub. Date: Jul. 22, 2021

(54) METHOD AND APPARATUS FOR PREDICTING CUSTOMER PURCHASE INTENTION, ELECTRONIC DEVICE AND MEDIUM

(71) Applicant: PING AN TECHNOLOGY (SHENZHEN) CO., LTD., Shenzhen, Guangdong (CN)

(72) Inventors: Fang LI, Shenzhen (CN); Jianming WANG, Shenzhen (CN); Jing XIAO, Shenzhen (CN)

(21) Appl. No.: 16/099,425

(22) PCT Filed: Jan. 31, 2018
(86) PCT No.: PCT/CN2018/074872

§ 371 Date: Nov. 6, 2018

(30) Foreign Application Priority Data
Aug. 24, 2017 (CN) 201710736859.2

(51) Int. Cl. G06Q 30/02; G06Q 10/06; G06N 20/20; G06N 5/00; G06N 5/04; G06F 40/30; H04M 3/523

(52) U.S. Cl. CPC G06Q 30/0202; G06Q 30/0201; G06Q 30/0255; G06Q 10/06311; G10L 15/26; G06N 5/003; G06N 5/04; G06F 40/30; H04M 3/5231; G06N 20/20

(57) ABSTRACT

The present solution provides a method and apparatus for predicting a customer purchase intention, an electronic device and a medium, which is applicable to the field of information processing. The method includes: obtaining personal characteristics data of a customer; inputting the personal characteristic data into a pre-established random forest model, to output an objective purchase tendency value of the customer; obtaining a subjective purchase tendency value of the customer according to an emotional tendency of the customer in a historical telemarketing process; weighting the objective purchase tendency value and the subjective purchase tendency value, and outputting the weighted result as an actual purchase tendency degree of the customer; and determining the customer whose actual purchase tendency degree is greater than a preset threshold as a potential customer, so that a telephone sales person makes a telephone call back to the potential customer and market a telemarketed product. According to the present solution, the potential customer is determined by integrating multi-aspect consideration factors, and therefore the forecast accuracy of the potential customer is improved; by weighting the objective purchase tendency value and the subjective purchase tendency value, the quantitative calculation of the customer purchase intention is achieved.

The present application claims priority of Chinese Patent Application with application No. 201710736859.2, entitled “METHOD FOR PREDICTING CUSTOMER PURCHASE INTENTION AND ELECTRONIC DEVICE”, filed with state intellectual property office on Aug. 24, 2017, the contents of which are incorporated herein by reference in entirety.

### TECHNICAL FIELD

The present application relates to the field of information processing, and particularly to a method and an apparatus for predicting a customer purchase intention, an electronic device and a medium.

### BACKGROUND

Currently, product marketing methods include telemarketing, email marketing, short-message marketing, etc. Telemarketing is a planned, organized, and efficient way to expand the customer base by using phones. In order to avoid that a telephone sales person can only randomly make a large number of calls, and rely on luck to sell products to phone receivers, at present, major companies have begun to achieve personalized precision marketing. Specifically, through in-depth analysis of the collected personal characteristics data of each user, different consumption characteristics of different customers are determined, so that the customer is confirmed as a potential customer when the marketing product and the customer's consumption characteristics are relatively consistent, and therefore telephone sales persons conduct telemarketing to the potential customer, it can be ensured accordingly that after each telemarketing, there is a greater probability that the customer will be converted into the actual customer who purchases the product, thereby improving marketing efficiency.

However, in the prior art, whether the customer is a potential customer is directly evaluated only based on the customer's personal characteristic data, the consideration factor is single, and the method cannot quantify the customer's product purchase intention. As a result, it is difficult to find a customer who truly has the intention to purchase the product promoted through telemarketing.

### SUMMARY

In view of this, an embodiment of the present application provides a method and apparatus for predicting customer purchase intention, an electronic device and a medium, which aims at solving the problem in the prior art that, when a potential customer is determined, the consideration factor is single and the customer's product purchase intention cannot be quantified.

A first aspect of an embodiment of the present application provides a method for predicting a customer purchase intention, including:

obtaining personal characteristics data of a customer;

inputting the personal characteristic data into a pre-established random forest model related to a telemarketed product, to output an objective purchase tendency value of the customer for the telemarketed product;

obtaining a subjective purchase tendency value of the customer for the telemarketed product according to the emotional tendency of the customer in the historical telemarketing process;

weighting the objective purchase tendency value and the subjective purchase tendency value, and outputting the weighted result as an actual purchase tendency degree of the customer;

determining the customer whose actual purchase tendency degree is greater than a preset threshold as a potential customer, so that a telephone sales person performs telephone follow-up on the potential customer and market the telemarketed product.

A second aspect of an embodiment of the present application provides an apparatus for predicting a customer purchase intention, including:

a first obtaining unit configured to obtain personal characteristics data of a customer;

a first output unit configured to input the personal characteristic data into a pre-established random forest model related to a telemarketed product, to output an objective purchase tendency value of the customer for the telemarketed product;

a second obtaining unit configured to obtain a subjective purchase tendency value of the customer for the telemarketed product according to an emotional tendency of the customer in a historical telemarketing process;

a weighting unit configured to weight the objective purchase tendency value and the subjective purchase tendency value, and output the weighted result as an actual purchase tendency degree of the customer; and

a determination unit configured to determine the customer whose actual purchase tendency degree is greater than a preset threshold as a potential customer, so that a telephone sales person performs telephone follow-up on the potential customer and market the telemarketed product.

A third aspect of an embodiment of the present application provides an electronic device including a memory and a processor, where the memory stores a computer readable instruction executable on the processor, and when the processor executes the computer readable instruction, the steps of the method for predicting the customer purchase intention as described in the first aspect are implemented.

A fourth aspect of an embodiment of the present application provides a computer readable storage medium, where the computer readable storage medium stores a computer readable instruction, and when the computer readable instruction is executed by the processor, the steps of the method for predicting the customer purchase intention as described in the first aspect are implemented.

In an embodiment of the present application, by inputting personal characteristic data of a customer into a preset random forest model, the customer's purchase tendency value on the telemarketed product at the objective level can be calculated; by obtaining the emotional tendency of the customer in the historical telemarketing process, the customer's purchase tendency value on the telemarketed product at a subjective level can be calculated; since the customer's actual purchase tendency degree output finally is the weighted result of the objective purchase tendency value and the subjective purchase tendency value, quantitative calculation of the customer purchase intention is achieved, so that the finally determined potential customers are potential customers who are obtained by integrating multi-aspect consideration factors, and therefore the prediction accuracy of potential customers is improved. At the same time, by enabling telephone sales persons to perform telephone follow-up on the potential customers and to market the telemarketed product, the neglect of historical telemarketing customers can be avoided, which further reduces a customer churn rate.

### BRIEF DESCRIPTION OF DRAWINGS

FIG. 1 illustrates an implementation flowchart of a method for predicting a customer purchase intention provided by an embodiment of the present application;

FIG. 2 illustrates a specific implementation flowchart of step 5103 in a method for predicting a customer purchase intention provided by an embodiment of the present application;

FIG. 3 illustrates a specific implementing flowchart of step 5104 in a method for predicting a customer purchase intention according to an embodiment of the present application;

FIG. 4 illustrates an implementation flowchart of a method for predicting a customer purchase intention provided by another embodiment of the present application;

FIG. 5 illustrates an implementation flowchart of a method for predicting a customer purchase intention provided by a further embodiment of the present application;

FIG. 6 illustrates a structure diagram of an apparatus for predicting a customer purchase intention provided by an embodiment of the present application;

FIG. 7 illustrates a structure diagram of an apparatus for predicting a customer purchase intention provided by an embodiment of the present application;

FIG. 8 illustrates a structure diagram of an apparatus for predicting a customer purchase intention provided by another embodiment of the present application;

FIG. 9 illustrates a structure diagram of an apparatus for predicting a customer purchase intention provided by a further embodiment of the present application; and

FIG. 10 illustrates a schematic diagram of an electronic device according to an embodiment of the present application.

### DESCRIPTION OF EMBODIMENTS

In order to explain the technical solutions described in the present application, the technical solutions of the present application will be described with reference to specific embodiments.

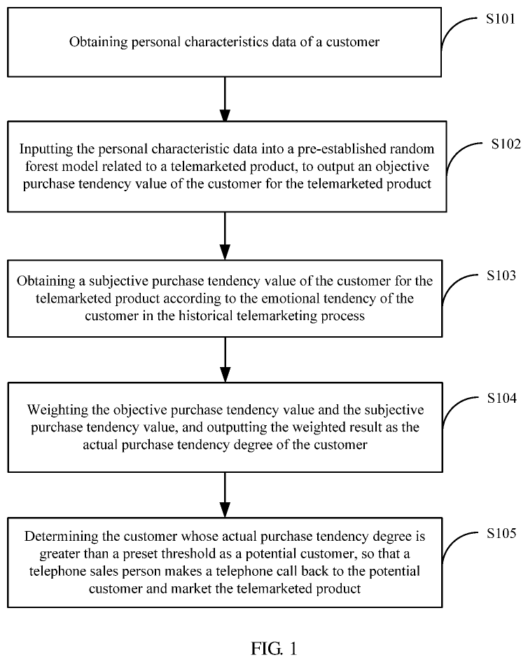

FIG. 1 illustrates an implementation flow of a method for predicting a customer purchase intention according to an embodiment of the present application. The method includes steps S101 to S105. Specific implementation principles of each step are as follows:

Step S101: obtaining personal characteristics data of a customer. Customers are historical telemarketing customers who have the possibility to purchase telemarketed products, and are used to dig out customers who have a relatively higher tendency to purchase the products and need to be subjected to telemarketing again. Under the conditions that telemarketed products and telemarketing services meet customer needs, the customers can be transformed into actual customers who purchase products. The telemarketed products are products sold by telephone sales persons to the customers by means of telephone communication, including but not limited to insurance products, credit products and other financial products.

The customers who have been marketed by each telephone sales person and the sales information related to the customers are recorded in a database. Marketing information related to the customers includes the personal characteristic data of the customers. Therefore, for one of the customers, the customer's personal characteristic data can be read from the database. The personal characteristics data includes, but is not limited to, age, income, hobbies, education, historical consumption of financial products, and life insurance premiums.

Step S102: inputting the personal characteristic data into a pre-established random forest model related to a telemarketed product, to output an objective purchase tendency value of the customer for the telemarketed product.

In the embodiment of the present application, a pre-trained random forest model is obtained. The random forest model includes a plurality of decision trees, and each of the decision tree is used for classification and selection based on input parameters. After classification and selection results of each decision tree are statistically summarized, a final output parameter of the random forest model is obtained. An input parameter is the personal characteristic data of the current customer. The output parameter is the objective purchase tendency value of the customer. A size of the objective purchase tendency value characterizes the possibility that the customer purchases a telemarketed product under objective conditions, and also characterizes a degree of characteristic matching between the customer's personal characteristic data and the telemarketed product.

Specifically, a plurality of training sample data is inputted into a pre-built random forest model. Each training sample data includes various personal characteristic data and a customer type of a historical marketing customer. The historical marketing customers in each training sample data are customers to whom telephone sales persons market the same telemarketed products, and the random forest model obtained through training is also related to the telemarketed product. The above customer type is an actual customer or a non-actual customer. That is, it depends on whether the customer on whom the telephone sales persons once performed marketing has finally purchased the telemarketed product. If yes, the historical marketing customer is the actual customer, and if no, the historical marketing customer is the non-actual customer.

Based on each obtained training sample data, model parameters in the random forest model are adjusted. Specifically, in the received N training sample data, the random sampling with replacement is repeatedly performed to take the extracted M (0<M<N, and M is an integer) training sample data as a new training sample set. Based on the new training sample set, K (K is an integer greater than 1) decision trees for classification are generated. Decision trees include binary trees and non-binary trees.

Since a model parameter adjustment method of the random forest model is the prior art in the art, it will not be discussed in detail any longer.

Step S103: obtaining a subjective purchase tendency value of the customer for the telemarketed product according to the emotional tendency of the customer in the historical telemarketing process.

For each customer, the emotional tendency in the historical telemarketing process is based on the customer's subjective reaction attitude, which includes positive, neutral, aversive and other types of emotional tendencies.

Illustratively, the customer's emotional tendency in the historical telemarketing process can be obtained by the following modes: the telephone sales persons can judge the type of the customer's emotional tendency in each process of telephone contact with the customer, and record the judgment result as the marketing information related to the customer, and then store the information in a database. Therefore, when the customer's product purchase intention is predicted, the latest data record corresponding to the customer can be read from the database, and the emotional tendency of the customer stored therein can be read.

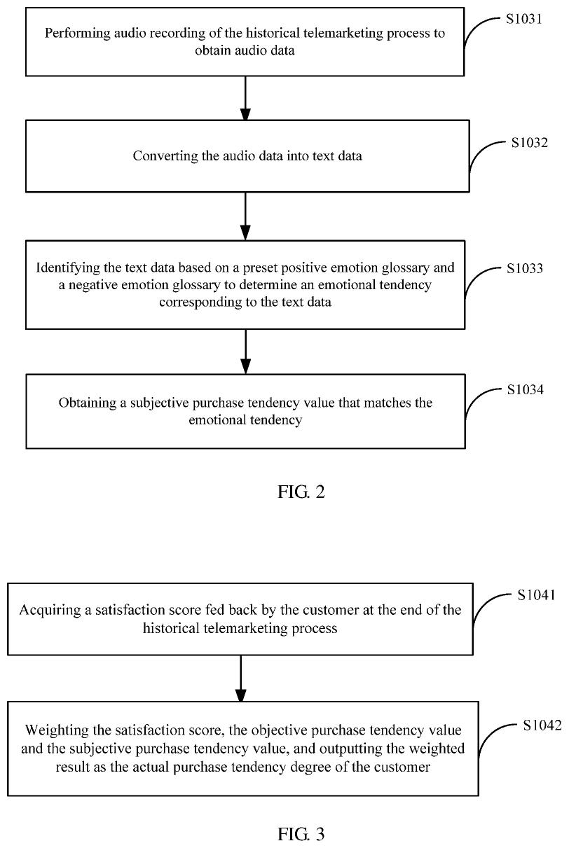

As an embodiment of the present application, as shown in FIG. 2, the foregoing step S103 specifically includes:

Step S1031: performing audio recording of the historical telemarketing process to obtain audio data.

In the embodiment of the present application, the telephone sales persons conduct telephone communication with the customers through a smart terminal in which communication software is installed, to perform product marketing. When the smart terminal detects that the current telephone sales person gets through the dialed telephone, an audio recording function carried by the communication software is triggered, to start to perform audio recording, and set the time to t1. When it is detected that the currently dialed call is interrupted, the audio recording is stopped, and the time is set to t2. The audio data obtained through recording between time t1 and time t2 is saved as an audio file, and the audio file corresponds to the customer contacted by the telephone sales person between time t1 and time t2.

Step S1032: converting the audio data into text data.

Step S1033: identifying the text data based on a preset positive emotion glossary and a negative emotion glossary to determine an emotional tendency corresponding to the text data.

The positive emotion glossary includes pre-collected words for expressing positive emotions, such as “very good”, “satisfied” and “good”. The negative emotion glossary includes pre-collected words for expressing negative emotions, such as “very bad”, “harassing”, and “very annoying”. When the text data is identified, the text data is firstly subjected to word segmentation processing to obtain a plurality of segmented words corresponding to the text data.

It is determined whether each segmented word exists in the positive emotion glossary or the negative emotion glossary. If a segmented word in the text data exists in the positive emotion glossary, the cumulative value used to express a degree of emotional tendency is incremented by one; and if a segmented word exists in the negative emotion glossary, the cumulative value used to express a degree of emotion tendency is reduced by one. According to the correspondence between the cumulative value and the emotional tendency, the emotional tendency corresponding to the finally obtained cumulative value is determined.

Preferably, in the embodiment of the present application, an emotion classification model may also be trained based on a plurality of text training data marked with emotional tendencies. At this time, if each segmented word in the text data obtained through conversion of the aforementioned voice data does not appear in either the positive emotion glossary or the negative emotion glossary, the text data is inputted into the pre-trained emotion classification model to output the emotional tendency corresponding to the text data.

Step S1034: obtaining a subjective purchase tendency value that matches the emotional tendency.

In the embodiment of the present application, different emotional tendencies correspond to different subjective purchase tendency values. According to the correspondence between the subjective purchase tendency value and the emotional tendency, a subjective purchase tendency value corresponding to an emotional tendency at the current moment is determined.

For example, if the emotional tendency is very satisfied, the corresponding subjective purchase tendency value is 100%; if the emotional tendency is positive, the corresponding subjective purchase tendency value is 90%; and if the emotional tendency is aversive, the corresponding subjective purchase tendency value is 0%.

Step S104: weighting the objective purchase tendency value and the subjective purchase tendency value, and outputting the weighted result as the actual purchase tendency degree of the customer.

The objective purchase tendency value and the subjective purchase tendency value respectively have a corresponding weight ratio. If the objective purchase tendency value obtained by the above steps is a, the corresponding preset weight ratio is A, and the subjective purchase tendency value is b, and the corresponding weight ratio is B, then the customer's calculated actual purchase tendency degree is: C=A*a+B*b.

Preferably, the weight ratio corresponding to the subjective purchase tendency value is greater than the weight ratio corresponding to the objective purchase tendency value.

As a specific embodiment of the present application, the weight ratio corresponding to the objective purchase tendency value is preferably 35%, and the weight ratio corresponding to the subjective purchase tendency value is preferably 65%, and then the actual purchase tendency value C of the customer can be calculated by the following formula:

C=A*35%+B*65%,

where the above A is an objective purchase tendency value, and the above B is a subjective purchase tendency value.

In the embodiment of the present application, because the subjective purchase tendency value of the customer can more accurately reflect the subjective attitude tendency of the customer for a telemarketed product, and whether the customer performs a purchase operation is usually directly related to the subjective attitude tendency, the weight ratio corresponding to the subjective purchase tendency value is set to be greater than the weight ratio corresponding to the objective purchase tendency value, the calculated actual purchase tendency degree of the customer will have a relatively higher reference value under a condition that the weight ratio corresponding to the subjective purchase tendency value is preferably 65% and the weight ratio corresponding to the objective purchase tendency value is 35%, so that the recognition accuracy of the potential customers can be further improved.

Step S105: determining the customer whose actual purchase tendency degree is greater than a preset threshold as a potential customer, so that a telephone sales person makes a telephone call back to the potential customer and market the telemarketed product.

If the actual purchase tendency degree of the customer at the current moment is lower than the preset threshold, it means that even if the telephone sales person makes a telemarketing for the customer, it is difficult to convert the customer into an actual customer. Therefore, in order to improve the marketing efficiency of the telephone sales person, only a customer whose actual purchase tendency degree is greater than a preset threshold is determined to be a potential customer. By recommending the determined potential customer to the telephone sales person, the telephone sales person perform telephone follow-up within a limited time to a historical telemarketing customer with a higher product purchase probability, so as to perform marketing again, thereby maximizing a customer conversion rate.

In an embodiment of the present application, by inputting personal characteristic data of a customer into a preset random forest model, the customer's purchase tendency value on the telemarketed product at the objective level can be calculated; by obtaining the emotional tendency of the customer in the historical telemarketing process, the customer's purchase tendency value on the telemarketed product at a subjective level can be calculated; since the customer's finally output actual purchase tendency degree is the weighted result of the objective purchase tendency value and the subjective purchase tendency value, quantitative calculation of the customer purchase intention is achieved, the finally determined potential customers are potential customers who are obtained by integrating multi-aspect consideration factors, so that the prediction accuracy of potential customers is improved. At the same time, by enabling telephone sales persons to perform telephone follow-up on the potential customers and to market the telemarketed product, the neglect of historical telemarketing customers can be avoided, which further reduces a customer churn rate.

As an embodiment of the present application, on the basis of the above embodiments, a weighting manner of the actual purchase tendency degree of the customer is further defined. As shown in FIG. 3, the above step S104 includes:

Step S1041: acquiring a satisfaction score fed back by the customer at the end of the historical telemarketing process.

At the end of each telemarketing process, the customer can receive a satisfaction score prompt message. The satisfaction score prompt message is used to prompt the customer to score the telemarketing service level of this time or the marketing level of the telephone sales person. After the customer presses a score value in a dialing keyboard of a communication terminal or replying to the score value by means of a short message, a satisfaction score fed back by the customer can be received. When the score value is higher, the customer's satisfaction degree is higher.

The satisfaction score that each customer feeds back at the end of the telemarketing process is also stored in the database. The satisfaction score fed back by the customer most recently is read from the database before the actual purchase tendency degree of the customer is calculated.

Step S1042: weighting the satisfaction score, the objective purchase tendency value and the subjective purchase tendency value, and outputting the weighted result as the actual purchase tendency degree of the customer.

In the embodiment of the present application, since the satisfaction score shows the satisfaction degree of the customer to the telemarketed product or the telemarketing service and can accurately reflect the most realistic subjective tendency of the customer to a certain extent, the actual purchase tendency degree of the customer is calculated jointly based on the satisfaction score, the objective purchase tendency value and the subjective purchase tendency value, which can reduce the prediction error of the actual purchase tendency degree caused by the theoretically analyzed value of the subjective purchase tendency value, and therefore improve the accuracy of the customer's actual purchase tendency degree.

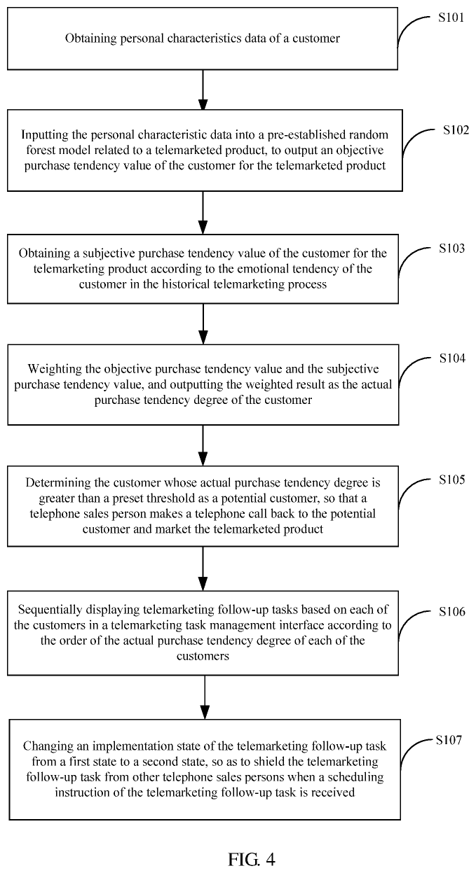

As an embodiment of the present application, as shown in FIG. 4, after the step S105, the method further includes:

Step S106: sequentially displaying telemarketing follow-up tasks based on each of the customers in a telemarketing task management interface according to the order of the actual purchase tendency degree of each of the customers.

In the embodiment of the present application, when the actual purchase tendency degree of the customer is greater than a preset threshold, in the telemarketing task management interface, a telemarketing follow-up task based on the customer is generated. Any of the telephone sales persons can log in to a telemarketing task management system by using own telephone sales person account, so as to view the telemarketing follow-up tasks displayed in the telemarketing task management interface.

For a plurality of customers whose actual purchase tendency degrees are greater than the preset threshold, according to the sizes of the values of the actual purchase tendency degree, the telemarketing follow-up tasks corresponding to each customer are sorted, so that the telemarketing follow-up task corresponding to the customer with a greater purchase tendency degree is arranged before the telemarketing follow-up task corresponding to the customer with a lower purchase tendency degree.

Step S107: changing an implementation state of the telemarketing follow-up task from a first state to a second state, so as to shield the telemarketing follow-up task from other telephone sales persons, when a scheduling instruction of the telemarketing follow-up task is received.

In the telemarketing task management interface, the telephone sales person can click to select a telemarketing follow-up task that needs to be followed up. At this time, a scheduling instruction based on the telemarketing follow-up task is received. The telemarketing follow-up task is bound to the telephone sales person account that issues the scheduling instruction, and the customer information related to the telemarketing follow-up task is sent to the telephone sales person account bound with the telemarketing follow-up task. The customer information related to the telemarketing follow-up task includes the customer's personal characteristic data, contact manner, actual purchase tendency degree, satisfaction score, and the like, thereby enabling the telephone sales person who obtains the customer information to perform telephone follow-up on the customer in time and conduct telemarketing operation.

In the embodiment of the present application, the implementation state of the telemarketing follow-up task is used to indicate the real-time processing progress of the telemarketing follow-up task, and the implementation state includes the first state and the second state. Illustratively, the first state is an unprocessed state and the second state is an allocated state. The implementation state of the telemarketing follow-up task can be represented by the color presented by the telemarketing follow-up task in the telemarketing task management interface. For example, the telemarketing follow-up task is marked in red to indicate that its implementation state is the first state; and the telemarketing follow-up task is marked in yellow to indicate that its implementation state is the second state.

When the telemarketing follow-up task is selected by any one of the telephone sales persons, the implementation state of the telemarketing follow-up task is changed to the second state. Since the telemarketing follow-up task in the second state cannot be clicked and selected again, the scheduling instruction based on the telemarketing follow-up task is not received again, and the shielding of other telephone sales persons is achieved.

In the embodiment of the present application, the telemarketing follow-up tasks based on each customer are sequentially displayed on the telemarketing task management interface, so that the telephone sales person can learn in real time which customer's real-time purchase tendency degree is the highest and which telemarketing follow-up task can achieve a good follow-up effect according to the arrangement order of the telemarketing follow-up tasks. When the scheduling instruction of the telemarketing follow-up task is received, the implementation state of the telemarketing follow-up task is changed from the first state to the second state, so that other telephone sales persons cannot repeatedly schedule the same telemarketing follow-up task, so as to avoid the situation that many telephone sales persons follow up the same customer, thereby improving the follow-up efficiency of the telemarketing task and the work efficiency of the telephone sales person, and further avoiding excessive telephone follow-up harassment to the customer.

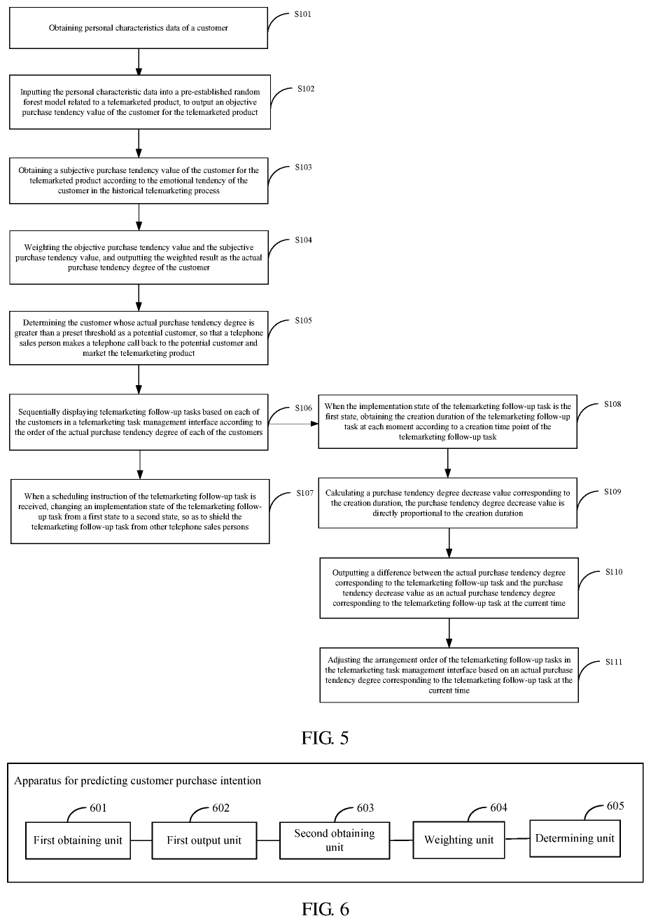

As an embodiment of the present application, on the basis of the above-mentioned embodiment, when the implementation state of the telemarketing follow-up task is the first state, the method for predicting the actual purchase tendency degree of the customer corresponding to the telemarketing follow-up task is further defined. As shown in FIG. 5, the aforesaid method for predicting the customer purchase intention further includes:

Step S108: obtaining the creation duration of the telemarketing follow-up task at each moment according to a creation time point of the telemarketing follow-up task.

In the embodiment of the present application, when the actual purchase tendency degree of the customer calculated for the first time is greater than a preset threshold, in the telemarketing task management interface, the telemarketing follow-up task based on the customer is generated and displayed, and the generation time of the telemarketing follow-up task is the creation time point of the telemarketing follow-up task.

When the telemarketing follow-up task is not scheduled by any one of the telephone sales persons, the implementation state of the telemarketing follow-up task remains at the first state. With time went on, when the telemarketing follow-up task exists for a longer time in the telemarketing task management interface, the creation duration of the telemarketing follow-up task is longer.

At any moment, the difference value between the system real time of the moment and the creation time point of the telemarketing follow-up task is determined as the creation duration of the telemarketing follow-up task.

Step S109: calculating a purchase tendency degree decrease value corresponding to the creation duration, and the purchase tendency degree decrease value is directly proportional to the creation duration.

Step S110: outputting a difference between the actual purchase tendency degree corresponding to the telemarketing follow-up task and the purchase tendency decrease value as an actual purchase tendency degree corresponding to the telemarketing follow-up task at the current time.

According to the creation duration of the telemarketing follow-up task at the current moment, the purchase tendency degree decrease value As corresponding to the creation duration is outputted by using a preset purchase tendency decrease value calculation formula. The actual purchase tendency value corresponding to the telemarketing follow-up task in real time is adjusted to S-Δs. S indicates the actual purchase tendency degree corresponding to the telemarketing follow-up task at the creation time point. The above formula for calculating the purchase tendency decrease value is a proportional function, and the formula may be, for example, |y|=a×x. a is a preset constant coefficient, x is the creation duration of the telemarketing follow-up task, and y is the purchase tendency decrease value corresponding to the creation duration x. It can be seen that the greater the creation duration x of the telemarketing follow-up task, the greater the purchase tendency decrease value is.

Step S111: adjusting the arrangement order of the telemarketing follow-up tasks in the telemarketing task management interface based on an actual purchase tendency degree corresponding to the telemarketing follow-up task at the current time.

The arrangement order of the various telemarketing follow-up tasks in the telemarketing task management interface indicates the actual purchase tendency degree corresponding to the telemarketing follow-up task. Therefore, if the telemarketing follow-up task is not scheduled, it can be learned from the above steps S108 to S110, the actual purchase tendency degree corresponding to the telemarketing follow-up task becomes lower and lower, so the arrangement order of the telemarketing follow-up task in the telemarketing task management interface will also be adjusted in real time. When the customer's actual purchase tendency degree is less than the preset threshold, the telemarketing follow-up task is deleted.

In the embodiment of the present application, since the determined potential customers are customers who are selected from the historical telemarketing customers and have a higher possibility for purchasing the telemarketing, if no telephone follow-up is performed on the potential customers for a long time, the telemarketed product purchase intention of the customer will also become lower and lower as time goes by. By adjusting the arrangement order of the telemarketing follow-up tasks in the telemarketing task management interface in real time, the telephone sales persons can learn which customers have a greater loss possibility based on the telemarketing follow-up tasks with a lower arrangement order. This has played a role in urging for follow-up.

It should be understood that the size of the serial numbers of the steps in the above embodiments does not mean that the order of execution. The order of execution of each process should be determined by its function and internal logic, and should not be construed as limiting the implementation process of an embodiment of the present application.

Corresponding to the method for predicting the customer purchase intention described in the above embodiment, FIG. 6 illustrates a structure diagram of an apparatus for predicting a customer purchase intention according to an embodiment of the present application. For ease of description, only the parts related to the present embodiment are shown.

Referring to FIG. 6, the apparatus includes:

a first obtaining unit 601 configured to obtain personal characteristics data of a customer;

a first output unit 602 configured to input the personal characteristic data into a pre-established random forest model related to a telemarketed product, so as to output an objective purchase tendency value of the customer for the telemarketed product;

a second obtaining unit 603 configured to obtain a subjective purchase tendency value of the customer for the telemarketed product according to an emotional tendency of the customer in a historical telemarketing process;

a weighting unit 604 configured to weight the objective purchase tendency value and the subjective purchase tendency value, and output the weighted result as an actual purchase tendency degree of the customer; and

a determination unit 605 configured to determine the customer whose actual purchase tendency degree is greater than a preset threshold as a potential customer, so that a telephone sales person can perform telephone follow-up to the potential customer and market the telemarketed product.

Optionally, the second obtaining unit 603 includes:

a recording subunit configured to perform audio recording of the historical telemarketing process to obtain audio data;

a conversion subunit configured to convert the audio data into text data;

an identification subunit configured to identify the text data based on a preset positive emotion glossary and negative emotion glossary, so as to determine an emotional tendency corresponding to the text data;

a first obtaining subunit configured to obtain a subjective purchase tendency value that matches the emotional tendency.

Optionally, the weighting unit 604 includes:

a second obtaining subunit configured to obtain a satisfaction score fed back by the customer at the end of the historical telemarketing process; and

a weighting subunit configured to weight the satisfaction score, the objective purchase tendency value and the subjective purchase tendency value, and output the weighted result as the actual purchase tendency degree of the customer.

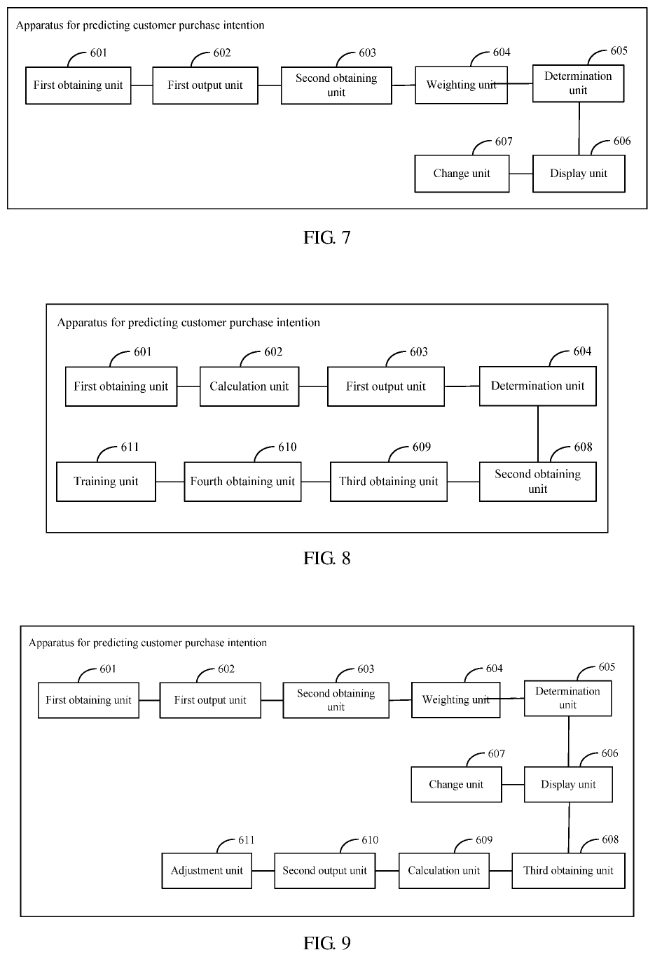

Optionally, as shown in FIG. 7, the apparatus for predicting the customer purchase intention further includes:

a presentation unit 606 configured to sequentially display telemarketing follow-up tasks based on each of the customers in a telemarketing task management interface according to an order of the actual purchase tendency degree of each of the customers;

a change unit 607 configured to change an implementation state of the telemarketing follow-up task from a first state to a second state when a scheduling instruction of the telemarketing follow-up task is received, so as to shield the telemarketing follow-up task from other telephone sales persons.

Optionally, when the implementation state of the telemarketing follow-up task is the first state, as shown in FIG. 9, the apparatus for predicting the customer purchase intention further includes:

a third obtaining unit 608 configured to obtain a creation duration of the telemarketing follow-up task at each moment according to a creation time point of the telemarketing follow-up task;

a calculation unit 609 configured to calculate a purchase tendency degree decrease value corresponding to the creation duration, where the purchase tendency degree decrease value is proportional to the creation duration;

a second output unit 610 configured to output a difference value between the actual purchase tendency degree corresponding to the telemarketing follow-up task and the purchase tendency decrease value as an actual purchase tendency degree corresponding to the telemarketing follow-up task at the current time; and an adjustment unit 611 configured to adjust the arrangement order of the telemarketing follow-up tasks in the telemarketing task management interface based on the actual purchase tendency degree corresponding to the telemarketing follow-up task at the current time.

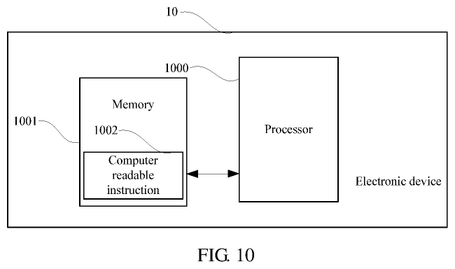

FIG. 10 is a schematic diagram of an electronic device according to an embodiment of the present application. As shown in FIG. 10, the electronic device 10 of this embodiment includes a processor 1000 and a memory 1001, where the memory 1001 stores a computer readable instruction 1002 that is executable on the processor 1000, such as a prediction program for a customer purchase intention. When the processor 1000 executes the computer readable instruction 1002, the steps in the embodiment of the method for predicting the purchase intention of each customer described above, such as steps 101 to 105 shown in FIG. 1, are implemented. Alternatively, when the processor 1000 implements the computer readable instruction 1002, functions of each module/unit in the apparatus embodiments described above, such as the functions of the units 601 to 605 shown in FIG. 6, are implemented.

Illustratively, the computer readable instruction 1002 can be partitioned into one or more modules/units, where the one or more modules/units are stored in the memory 1001 and are executed by the processor 1000, so as to complete the present application. The one or more modules/units may be a series of computer readable instruction segments capable of performing a particular function, where the instruction segments are used for describing the execution process of the computer readable instructions 1002 in the electronic device 10.

The electronic device 10 can be a computing device such as a desk calculator, a notebook, a palmtop computer, and a cloud server. The electronic device may include, but is not limited to, the processor 1000, and the memory 1001. It will be understood by those skilled in the art that FIG. 10 is merely an example of the electronic device 10 and does not constitute a limitation on the electronic device 10, and may include more or less components than those illustrated, or combine some components, or different components. For example, the electronic device may further include an input/output device, a network access device, a bus, and the like.

The processor 1000 may be a CPU (Central Processing Unit), or may be other general-purpose processors, a DSP (Digital Signal Processor), an ASIC (Application Specific Integrated Circuit), a FPGA (Field-Programmable Gate Array) or other programmable logic devices, discrete gates or transistor logic devices, discrete hardware components, and the like. The general-purpose processor may be a microprocessor or the processor may be any conventional processor, and the like.

The memory 1001 may be an internal storage unit of the electronic device 10, such as a hard disk or a memory of the electronic device 10. The memory 1001 may also be an external storage device of the electronic device 10, such as a plug-in hard disk disposed on the electronic device 10, a SMC (Smart Media Card), a SD (Secure Digital) card, and a FC (Flash Card). Further, the memory 1001 may further include both an internal storage unit of the electronic device 10 and an external storage device. The memory 1001 is configured to store the computer readable instruction and other programs and data required by the electronic device. The memory 1001 may also be used to temporarily store data that has been outputted or is about to be outputted.

In addition, each functional unit in each embodiment of the present application may be integrated into one processing unit, or each unit may exist physically separately, or two or more units may be integrated into one unit. The above integrated unit may be implemented in the form of hardware or may also be implemented in the form of a software functional unit.

The integrated unit, if implemented in the form of a software functional unit and sold or used as an independent product, may be stored in a computer readable storage medium. Based on such understanding, the technical solution of the present application, in essence or the contribution to the prior art, or all or part of the technical solution may be embodied in the form of a software product. The computer software product is stored in a storage medium, and includes a plurality of instructions used to enable a computer device (which may be a personal computer, a server, or a network device, and the like) to perform all or part of the steps of the method described in the embodiments of the present application. The aforesaid storage medium includes the medium that can store program codes, such as a USB flash disk, a mobile hard disk, a ROM (Read-Only Memory), a RAM (Random Access Memory), a magnetic disk, or an optical disk, and the like.

The above embodiments are only used to illustrate the technical solutions of the present application, and are not intended to limit the technical solutions; although the present application has been described in detail with reference to the aforesaid embodiments, the ordinarily skilled one in the art should understand that they can still modify the technical solutions recorded in the aforesaid various embodiments, or perform equivalent substitutions on some of the technical features in the embodiments; and such modifications or substitutions do not make the essence of the corresponding technical solution depart from the spirit and the scope of the technical solution of each embodiment of the present application.

1. A method for predicting a customer purchase intention, comprising:
obtaining personal characteristics data of a customer;
inputting the personal characteristic data into a pre-established random forest model related to a telemarketed product, to output an objective purchase tendency value of the customer for the telemarketed product;
obtaining a subjective purchase tendency value of the customer for the telemarketed product according to an emotional tendency of the customer in the historical telemarketing process;
weighting the objective purchase tendency value and the subjective purchase tendency value, and outputting a weighted result as an actual purchase tendency degree of the customer; and
determining the customer whose actual purchase tendency degree is greater than a preset threshold as a potential customer, so that a telephone sales person performs telephone follow-up on the potential customer and market the telemarketed product.

2. The method for predicting a customer purchase intention according to claim 1, wherein the obtaining a subjective purchase tendency value of the customer for the telemarketed product according to an emotional tendency of the customer in a historical telemarketing process comprises:
performing audio recording of the historical telemarketing process to obtain audio data;
converting the audio data into text data;
identifying the text data based on a preset positive emotion glossary and negative emotion glossary to determine an emotional tendency corresponding to the text data; and
obtaining a subjective purchase tendency value that matches the emotional tendency.

3. The method for predicting a customer purchase intention according to claim 1, wherein the weighting the objective purchase tendency value and the subjective purchase tendency value, and outputting a weighted result as an actual purchase tendency degree of the customer comprises:
obtaining a satisfaction score fed back by the customer at the end of the historical telemarketing process; and
weighting the satisfaction score, the objective purchase tendency value and the subjective purchase tendency value, and outputting the weighted result as the actual purchase tendency degree of the customer.

4. The method for predicting a customer purchase intention according to claim 1, further comprising:
sequentially displaying telemarketing follow-up tasks based on each of the customers in a telemarketing task management interface according to an order of the actual purchase tendency degree of each of the customers; and
changing an implementation state of the telemarketing follow-up task from a first state to a second state, so as to shield the telemarketing follow-up task from other telephone sales persons, when a scheduling instruction of the telemarketing follow-up task is received.

5. The method for predicting a customer purchase intention according to claim 4, wherein when the implementation state of the telemarketing follow-up task is the first state, the method further comprises:
obtaining a creation duration of the telemarketing follow-up task at each moment according to a creation time point of the telemarketing follow-up task;
calculating a purchase tendency degree decrease value corresponding to the creation duration, wherein the purchase tendency degree decrease value is directly proportional to the creation duration;
outputting a difference value between the actual purchase tendency degree corresponding to the telemarketing follow-up task and the purchase tendency decrease value as an actual purchase tendency degree corresponding to the telemarketing follow-up task at the current time; and
adjusting the arrangement order of the telemarketing follow-up tasks in the telemarketing task management interface based on the actual purchase tendency degree corresponding to the telemarketing follow-up task at the current time.

6-10. (canceled)

11. An electronic device, comprising a memory and a processor, wherein the memory stores a computer readable instruction executable on the processor, and when the processor implements the computer readable instruction, the following steps are implemented:
obtaining personal characteristics data of a customer;
inputting the personal characteristic data into a pre-established random forest model related to a telemarketed product, to output an objective purchase tendency value of the customer for the telemarketed product;
obtaining a subjective purchase tendency value of the customer for the telemarketed product according to the emotional tendency of the customer in the historical telemarketing process;
weighting the objective purchase tendency value and the subjective purchase tendency value, and outputting the weighted result as an actual purchase tendency degree of the customer;
determining the customer whose actual purchase tendency degree is greater than a preset threshold as a potential customer, so that a telephone sales person performs telephone follow-up on the potential customer and market the telemarketed product.

12. The electronic device according to claim 11, wherein the obtaining the subjective purchase tendency value of the customer for the telemarketed product according to the emotional tendency of the customer in the historical telemarketing process comprises:
performing audio recording of the historical telemarketing process to obtain audio data;
converting the audio data into text data;
identifying the text data based on a preset positive emotion glossary and negative emotion glossary to determine an emotional tendency corresponding to the text data; and
obtaining a subjective purchase tendency value that matches the emotional tendency.

13. The electronic device according to claim 11, wherein the weighting the objective purchase tendency value and the subjective purchase tendency value, and outputting a weighted result as the actual purchase tendency degree of the customer comprises:
obtaining a satisfaction score fed back by the customer at the end of the historical telemarketing process; and
weighting the satisfaction score, the objective purchase tendency value and the subjective purchase tendency value, and outputting the weighted result as the actual purchase tendency degree of the customer.

14. The electronic device according to claim 11, wherein when the processor executes the computer readable instructions, the following steps are further implemented:
sequentially displaying telemarketing follow-up tasks based on each of the customers in a telemarketing task management interface according to an order of the actual purchase tendency degree of each of the customers; and
changing an implementation state of the telemarketing follow-up task from a first state to a second state, so as to shield the telemarketing follow-up task from other telephone sales persons, when a scheduling instruction of the telemarketing follow-up task is received.

15. The electronic device according to claim 14, wherein if the implementation state of the telemarketing follow-up task is the first state, when the processor executes the computer readable instructions, the following steps are further implemented:
obtaining a creation duration of the telemarketing follow-up task at each moment according to a creation time point of the telemarketing follow-up task;
calculating a purchase tendency degree decrease value corresponding to the creation duration, wherein the purchase tendency degree decrease value is directly proportional to the creation duration;
outputting a difference value between the actual purchase tendency degree corresponding to the telemarketing follow-up task and the purchase tendency decrease value as an actual purchase tendency degree corresponding to the telemarketing follow-up task at the current time; and
adjusting the arrangement order of the telemarketing follow-up tasks in the telemarketing task management interface based on the actual purchase tendency degree corresponding to the telemarketing follow-up task at the current time.

16. A computer readable storage medium which stores a computer readable instruction, and when the computer readable instruction is executed by at least one processor, the following steps are implemented:
obtaining personal characteristics data of a customer;
inputting the personal characteristic data into a pre-established random forest model related to a telemarketed product, to output an objective purchase tendency value of the customer for the telemarketed product;
obtaining a subjective purchase tendency value of the customer for the telemarketed product according to the emotional tendency of the customer in the historical telemarketing process;
weighting the objective purchase tendency value and the subjective purchase tendency value, and outputting the weighted result as an actual purchase tendency degree of the customer; and
determining the customer whose actual purchase tendency degree is greater than a preset threshold as a potential customer, so that a telephone sales person performs telephone follow-up on the potential customer and market the telemarketed product.

17. The computer readable storage medium according to claim 16, wherein the obtaining the subjective purchase tendency value of the customer for the telemarketed product according to an emotional tendency of the customer in a historical telemarketing process comprises:
performing audio recording of the historical telemarketing process to obtain audio data;
converting the audio data into text data;
identifying the text data based on a preset positive emotion glossary and negative emotion glossary to determine an emotional tendency corresponding to the text data; and
obtaining a subjective purchase tendency value that matches the emotional tendency.

18. The computer readable storage medium according to claim 16, wherein the weighting the objective purchase tendency value and the subjective purchase tendency value, and outputting the weighted result as an actual purchase tendency degree of the customer comprises:
obtaining a satisfaction score fed back by the customer at the end of the historical telemarketing process; and
weighting the satisfaction score, the objective purchase tendency value and the subjective purchase tendency value, and outputting the weighted result as the actual purchase tendency degree of the customer.

19. The computer readable storage medium according to claim 16, wherein when the computer readable instruction is executed by at least one processor, the following steps are further implemented:
sequentially displaying telemarketing follow-up tasks based on each of the customers in a telemarketing task management interface according to an order of the actual purchase tendency degree of each of the customers; and
changing an implementation state of the telemarketing follow-up task from a first state to a second state, so as to shield the telemarketing follow-up task from other telephone sales persons, when a scheduling instruction of the telemarketing follow-up task is received.

20. The computer readable storage medium according to claim 19, wherein if the implementation state of the telemarketing follow-up task is the first state, when the computer readable instruction is executed by at least one processor, the following steps are further implemented:
obtaining a creation duration of the telemarketing follow-up task at each moment according to a creation time point of the telemarketing follow-up task;
calculating a purchase tendency degree decrease value corresponding to the creation duration, wherein the purchase tendency degree decrease value is directly proportional to the creation duration;
outputting a difference value between the actual purchase tendency degree corresponding to the telemarketing follow-up task and the purchase tendency decrease value as an actual purchase tendency degree corresponding to the telemarketing follow-up task at the current time; and
adjusting the arrangement order of the telemarketing follow-up tasks in the telemarketing task management interface based on the actual purchase tendency degree corresponding to the telemarketing follow-up task at the current time.
